(19) United States
(12) Patent Application Publication
(10) Pub. No.: US 2011/0137723 A1
(43) Pub. Date: Jun. 9, 2011

(54) NODE NAME BASED CONTENT DELIVERY

(75) Inventor: Ola Karl Thörn, Malmo (SE)

(73) Assignee: SONY ERICSSON MOBILE COMMUNICATIONS AB, Lund (SE)

(21) Appl. No.: 12/633,066

(22) Filed: Dec. 8, 2009

(51) Int. Cl. G06F 15/16; G06Q 30/00

(52) U.S. Cl. 705/14.49; 709/217; 709/231

(57) ABSTRACT

A method may include receiving a media delivery request via a network. Node name information associated with the media delivery request may be received. An advertisement may be selected from a number of available advertisements based on the node name information. The selected advertisement may be included with the media. The media may be transmitted via the network.

### TECHNICAL FIELD OF THE INVENTION

The invention relates generally to networked media delivery devices and systems and, more particularly, to outputting media content to connected devices.

### DESCRIPTION OF RELATED ART

Conventional media delivery systems typically include client devices, such as personal computers or set-top boxes that request media resources from a server device, such as a web server via a network, such as the Internet. Examples of such media delivery systems include online radio stations, music streaming services, online video sites, etc. Many of these media delivery systems generate revenue by selling advertisement time within the delivered media. Ascertaining accurate and reliable information relating to an audience is paramount in setting advertising rates and maximizing revenue.

### SUMMARY

According to a first aspect, a method may include receiving a media delivery request via a network; receiving node name information associated with the media delivery request; selecting an advertisement from a number of available advertisements based on the node name information; including the selected advertisement with the media; and transmitting the media via the network.

In addition, the media delivery request comprises a request for a media stream, the node name information is associated with an output node for outputting the media stream, and the selected advertisement is inserted into the media stream.

In addition, the media stream comprises an audio stream.

In addition, the node name information includes a name of an output node selected to receive the media.

In addition, the output node comprises a speaker or a display.

In addition, the method may include determining node information based on the received node name information; and selecting the advertisement from the number of available advertisements based on the determined node information.

In addition, the media request is received from a user device, and wherein the media request includes the node information.

In addition, the node information comprises gender information, age information, or location-related activity information.

In addition, the received node name information includes first node name information associated with a first output node and second node name information associated with a second output node, and the method may include selecting a first advertisement from the number of available advertisements based on the first node name information; selecting a second advertisement from the number of available advertisements based on the second node name information; and including the first and second advertisements with the media, wherein the first and second advertisements include markers therein for associating the first advertisement with the first output node and the second advertisement with the second output node.

According to another aspect, a device may include a communication interface for communicating with a user device via a first network; a memory for storing media content and a number of advertisements; and logic configured to: receive a request for the media content from the user device; receive node name information associated with an output node of the user device; select an advertisement from a number of available advertisements based on the node name information; insert the selected advertisement into the media content; and transmit the media content to the output node via the first network.

In addition, the output node comprises a speaker or a display.

In addition, the user device communicates with the output node via a second network, and wherein the node name information is associated with the output node.

In addition, the request for media content comprises a request for a media stream, the output node outputs the media stream, and the selected advertisement is inserted into the media stream.

In addition, the node name information includes a name assigned to the output node.

In addition the logic is further configured to: determine node information based on the received node name information; and select the advertisement from the number of available advertisements based on the determined node information.

In addition, the determined node information comprises gender information, age information, location information, or activity information corresponding to an audience at the output node.

In still another aspect, a computer-readable medium having stored thereon a plurality of sequences of instructions which, when executed by at least one processor, cause the at least one processor to: store media content and advertisement content, wherein the advertisement content includes a number of advertisements; receive a user command to output the media content to a selected output node; obtain name information associated with the selected output node; determine node information based on the name information; select an advertisement from the number of advertisements based on the node information; insert the selected advertisement into the media content; and output the media content to the selected output node.

In addition, the instructions that cause the at least one processor to determine node information further comprise instructions to: determine a function associated with a location of the output node; determine a gender associated with an audience at the output node; or determine an age associated with the audience at the output node.

In addition, the instructions further cause the at least one processor to: receive the media content as a media stream from a network device via a computer network, wherein the instructions to select an advertisement from the number of advertisements based on the node information and insert the selected advertisement into the media content are performed at the network device.

In addition, the media stream comprises a substantially live audio or video stream.

### BRIEF DESCRIPTION OF THE DRAWINGS

Reference is made to the attached drawings, wherein elements having the same reference number designation may represent like elements throughout.

FIG. 1 is a diagram of an environment 100 which may be used in conjunction with devices, systems and methods described herein;

FIG. 2 is a diagram illustrating components of the user device, node, and/or service provider of FIG. 1 according to an exemplary implementation;

FIG. 3 is a functional block diagram of the user device of FIGS. 1 and 2;

FIG. 4 is a functional block diagram of the service provider of FIGS. 1 and 2; and

FIG. 5 is a flow diagram illustrating exemplary processing associated with performing node name based advertising in the environment of FIG. 1.

### DETAILED DESCRIPTION

The following detailed description refers to the accompanying drawings. The same reference numbers in different drawings may identify the same or similar elements.

In implementations described herein, a number of nodes or devices may connect via a local network and provide output devices with content served or provided over the network. A service provider or other entity may identify device locations or context within the local environment based on names or other nomenclature associated with each output node in the network. The service provider, or an affiliated entity, may provide advertisements to the nodes based on the identified location or context.

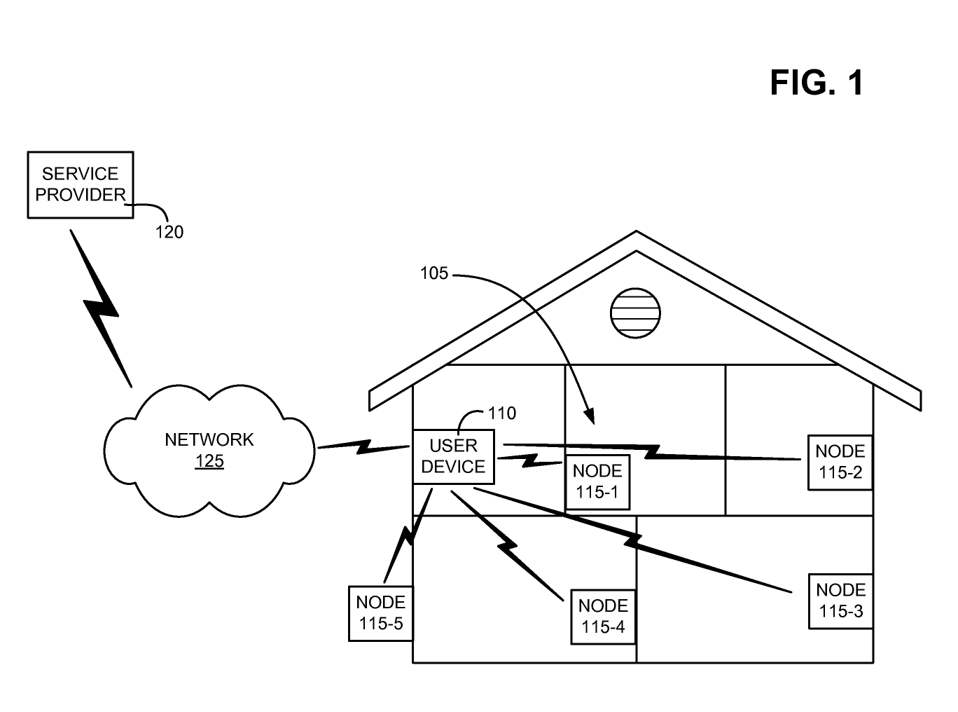

FIG. 1 is a diagram of an environment 100 which may be used in conjunction with devices, systems and methods described herein. As shown, environment 100 may include local network 105, a user device 110, output nodes 115-1 to 115-5 (collectively “nodes 115,” or individually “node 115”), service provider 120, and network 125.

Local network 105 may include a local area network (LAN), a wireless local area network (WLAN), a scatter net (e.g., a collection of one or more wireless personal area networks (WPANs)), and/or other types of networks that are capable of conveying multimedia content, such as streaming media content, and/or other types of information between devices on local network 105.

User device 110 may include any device capable of communicating with output nodes 115 and service provider 120 via networks 105 and 125, respectively. Exemplary user devices 110 may include a personal computer (PC), a laptop or netbook, a home theater PC (HTPC), a gaming console or platform (e.g., Playstation, Xbox, Wii, etc.), a media device, such as a Blu-Ray® player, a digital video disc (DVD) player, a set-top box (STB), etc. In other implementations, user device 110 may include a portable communication device, such as a mobile (or cellular) telephone, a portable media player (PMP) (e.g., an MPEG audio layer 3 (MP3) player); a portable videogame playing device; a smartphone; a personal digital assistant (PDA), etc.

Output nodes 115 may include networked communication devices configured to receive media content from user device 110, and output the media content to an output device, such as a speaker (or speakers), a display (e.g., a television), a PC, a DVD or Blu-Ray player, gaming console, etc. Output nodes 115 may receive or exchange multimedia content with other devices and/or output the multimedia content to an audience. In addition, output nodes 115 may discover other devices or nodes, control a delivery of multimedia content to the other nodes, and/or control the output of the multimedia content to the audience.

In FIG. 1, depending on the implementation and/or configuration, local network 105 may include additional, fewer, or different devices than the ones that are illustrated. For example, local network 105 may include other user devices 110 or nodes 115 that can communicate with each other. In addition, each device/node in local network 105 may include other nested devices. For example, a DVD player may include a digital clock as well as a streaming media player. Furthermore, depending on the particular manner in which a device is used, a node/device of one type (e.g., user device 110) may function or operate as a device of another type (e.g., node 115). For example, user device 110 may include a laptop computer that may also function as an output node 115 within network 105 for outputting received media content.

Depending on the implementation, each device in local network 105 may conform to one or more communication or network standards. For example, user device 110 and output nodes 115 may conform to the Digital Living Network Alliance (DLNA) guidelines. In such implementations, each of the devices in local network 105 may provide a basic set of functionalities for controlling and/or interacting with one another, transporting multimedia content, and/or presenting the multimedia content.

In other implementations consistent with embodiments described herein, local network 105 may include a wireless communication network, such as a 3G, GSM, or Edge network. In this implementation, output nodes 115 may include transceivers for exchanging information via the wireless communication network. For example, local network 105 may include a 3G data network and output nodes 115 and user device 110 (e.g., a cellular telephone) may include suitable 3G transceivers. By extending a range of media playback/output beyond a typical local area network (LAN), extension of the concepts described herein may be obtained.

In another embodiment, output nodes 115 and user device 110 may include location-determining technology, such as GPS logic, for determining a geographic location of the respective device. Using the location-determining technology, user device 110 and output nodes 115 may dynamically become aware of each other based on their respective geographic locations. For example, a GPS and 3G-enabled speaker system (node 115) may determine that a user's cell phone (user device 110) is within 100 yards of its location. The relative locations of the speaker system and the user's cell phone may be enabled by having each device support a location-sharing service. For example, each device may periodically update a location via, for example, a service similar to Google Latitude® or another similar service.

Service provider 120 may include one or more network devices for delivering media and related content to network 105 via network 125. For example, in some implementations service provider 120 may include a high speed Internet provider, such as a cable or communications provider. In other embodiments, service provider 120 may include a content server for providing (e.g., streaming) media content to user device 110 via network 125. Consistent with implementations described herein, service provider 120 may include or may be associated with (either directly or indirectly) an advertisement server for selecting and delivering advertisement media to user device via network 125.

Network 125 may include the Internet, an ad hoc network, a local area network (LAN), a wide area network (WAN), a metropolitan area network (MAN), a cellular network, a public switched telephone network (PSTN), an intranet, any other network, or a combination of networks. Local network 105 may be connected to network 125 by devices such as a firewall, a gateway, etc. (not shown).

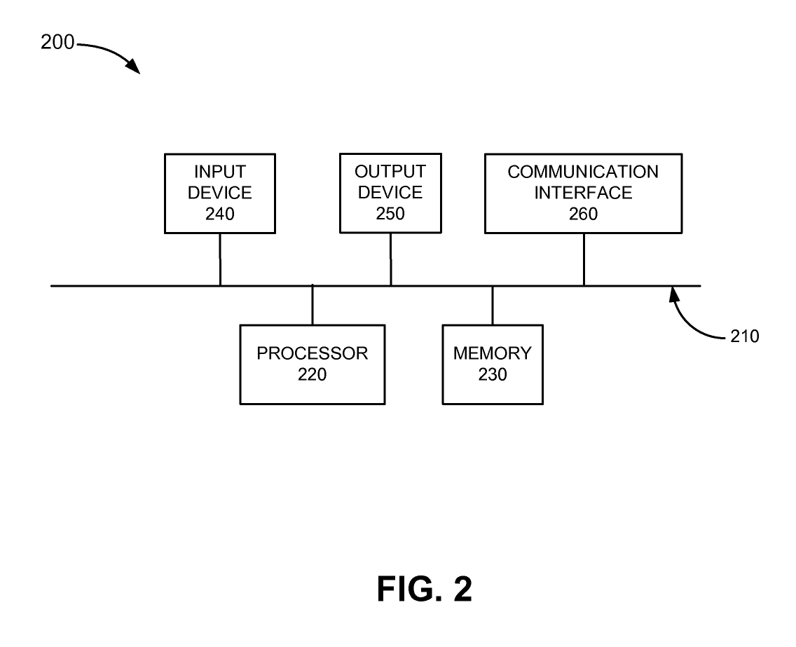

FIG. 2 is a diagram illustrating components of a device 200 according to an exemplary implementation. Device 200 may correspond to any of user device 110, output nodes 115, or service provider 120. Device 200 may include bus 210, processor 220, memory 230, input device 240, output device 250, and communication interface 260. Bus 210 permits communication among the components of device 200. One skilled in the art would recognize that device 200 may be configured in a number of other ways and may include other or different elements. For example, device 200 may include one or more modulators, demodulators, encoders, decoders, transceivers, etc., for receiving, transmitting, and/or processing data.

Processor 220 may include a processor, microprocessor, an application specific integrated circuit (ASIC), field programmable gate array (FPGA) or other processing logic. Processor 220 may execute software instructions/programs or data structures to control operation of device 200.

Memory 230 may include a random access memory (RAM) or another type of dynamic storage device that stores information and instructions for execution by processor 220; a read only memory (ROM) or another type of static storage device that stores static information and instructions for use by processor 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processor 220. Instructions used by processor 220 may also, or alternatively, be stored in another type of computer-readable medium accessible by processor 220. A computer-readable medium may include one or more memory devices.

Input device 240 may include any mechanism that permits an operator to input information to device 200, such as a keypad, a microphone, a keyboard, a mouse, a pen, voice recognition mechanisms, a visual gesture interpreting engine (incorporating, for example, a gyroscope, an accelerometer, etc), a global positioning satellite (GPS) receiver, etc. Input device 240 may also include one or more buttons that allow a user to receive a menu of options via output device 250. The menu may allow the user to select various functions or modes associated with applications executed by processor 220.

Output device 250 may include one or more mechanisms that output information to the user, one or more speakers, an audio or audio visual interface (e.g., HDMI, DVI, composite video, analog/digital audio, and/or component video interfaces), a display, such as an LCD, plasma, or LED display, a printer, a wired or wireless headset (e.g., a Bluetooth® headset), etc.

Communication interface 260 may include a transceiver that enables device 200 to communication with other devices and/or systems, e.g., via networks 105/125. For example, communication interface 260 may include a modem or an Ethernet interface to a LAN. Alternatively, communication interface 260 may include other mechanisms for communicating via a network, such as a wireless network. For example, communication interface 260 may include one or more radio frequency (RF) transmitters, receivers, and/or transceivers for communicating via a wireless (e.g., Wi-Fi) or cellular network.

In other implementations, communication interface 260 may include components for transmitting and receiving analog and/or digital telecommunications signals, such as GSM (global system for mobile communications), PCS (personal communication services), FDMA (frequency division multiple access), CDMA (code division multiple access), TDMA (time division multiple access), GPRS (General Packet Radio Service), EDGE (Enhanced Data Rates for GSM Evolution), and/or HSDPA (high speed downlink packet access) signals. Additionally, communication interface 260 may include components for transmitting and receiving short-range radio frequency (RF) signals associated with local network 105 (e.g., Bluetooth®, Wi-Fi (e.g., IEEE 802.11x), or WiMAX (e.g., IEEE 802.16x) networks). For example, communication interface 260 may output audio signals to a Bluetooth® or Wi-Fi connected accessory or headset.

Consistent with implementations described herein user device 110 and output nodes 115 may provide a platform that enables a user to output media from a source device (e.g., user device 110) to output node devices 115 via local network 105. Media content may be received (e.g., streamed) from service provider 120 to user device 110 via network 125. User device 110 and/or service provider 120, as described in detail below, may also perform processing associated with providing advertisements within the media content. The provided advertisements may be selected for delivery to user device 110 and/or output nodes 115 based at least in part, on a name associated with the output node (or nodes) 115 that receives the content from user device 110.

User device 110 and/or service provider 120 may perform these operations in response to processor 220 (in either of user device 110 and/or service provider 120) executing sequences of instructions contained in a computer-readable medium, such as memory 230. Such instructions may be read into memory 230 from another computer-readable medium via, for example, communication interface 260. A computer-readable medium may include one or more memory devices. In alternative embodiments, hard-wired circuitry may be used in place of or in combination with software instructions to implement processes consistent with the invention. Thus, implementations described herein are not limited to any specific combination of hardware circuitry and software. As described above, although the embodiments provided herein are described in terms of a single user device 110 and a single service provider 120, implementations consistent with this description may be provided by any suitable number of devices, including multiple user devices 105, as well as a number of network devices associated with service provider 120, such as content servers, advertisement servers, web servers, routers, switches, gateways, modems, etc.

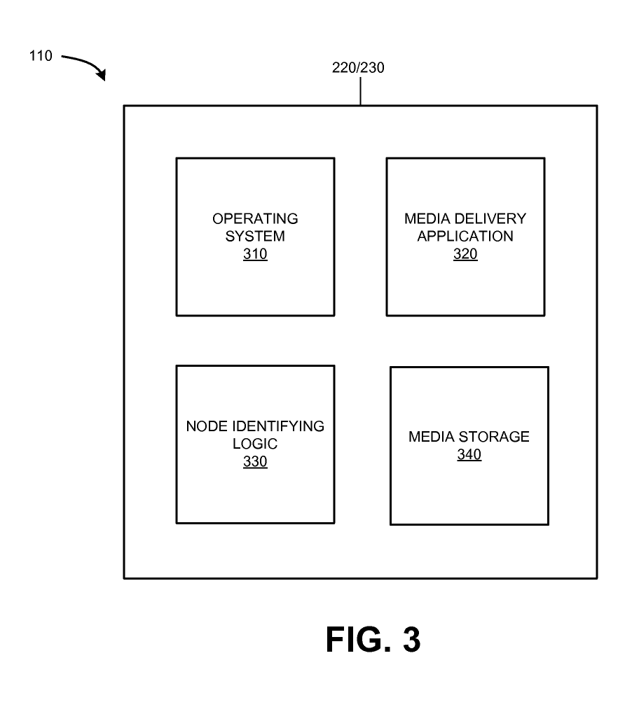

FIG. 3 illustrates one implementation of an exemplary functional block diagram of components implemented in user device 110. The logical blocks illustrated in FIG. 3 may be implemented in software, hardware, a combination of hardware and software. In one exemplary implementation, the logical blocks illustrated in FIG. 3 may be included in memory 230 in user device 110.

Referring to FIG. 3, memory 230 of user device 110 may include an operating system 310, a media delivery application 320, and node identifying logic 330 executable by processor 220. Memory(s) 230 may further include media content storage 340. Depending on the implementation, user device 110 may include additional, fewer, or different components than those illustrated in FIG. 3. For example, media delivery application 320 may include more than one media delivery application (e.g., a number of different streaming audio and video applications). In other implementation, a single media delivery application may integrate with other media applications (not shown) to output or distribute media to output nodes 115 via local network 105.

Operating system 310 may include logic configured to manage hardware and software resources of user device 100. Operating system 310 may manage, for example, its file system, device drivers, communication resources (e.g., radio receiver(s), transmission control protocol (TCP)/IP stack), event notifications, etc.

Media delivery application 320 may include logic configured to receive and output or “play” media content on user device 110 or on selectable output nodes 115. In one implementation, media delivery application 320 may receive user commands to output media content via a user interface. As briefly described above, media delivery application 320 may include a single executable application or may include more than one executable application. In one exemplary implementation, media delivery application 320 may communicate with output nodes 115 via local network 105. For example, media delivery application 320 may identify output nodes 115 on network 105 in a substantially transparent or automatic manner (also referred to as “device discovery”).

In one embodiment, media delivery application 320 may discover nodes 115 via a zero configuration protocol, such as zeroconf or Bonjour. In each implementation, nodes 115 may be configured to respond to device discovery requests from media delivery application 320 (or, more generally, user device 110) with an assigned node name and a description of the services supported on the node. For example, output node 115-1 may identify itself to user device 110 as “Susie's Room” and may list audio streaming (e.g., real time streaming protocol (RTSP)) in its description of supported services. In some instances multiple services may be supported by an output node 115. For example, output node 115-1 may be a PC that supports zero configuration of remote management, file sharing, and media streaming services. In this example, in response to a request, the discovering device (e.g., user device 110) may receive a listing of services corresponding to each supported service.

Although FIG. 1 generally depicts user device 110 and nodes 115 as existing in a home or residential setting, it should be understood that in some implementations, nodes 115 may be located in a commercial or business setting. For example, nodes associated with businesses, e.g., Starbucks®, McDonalds® may be assigned names corresponding to their commercial locations. In one example, an output node 115 at a Starbucks® coffee shop may be named “Starbucks 1243.”

Once “discovered” and available, media delivery application 320 may establish a delivery (e.g., streaming) session with each selected output node 115. For example, media delivery application 320 may establish a RTSP session with a selected output node 115 (e.g., a remote speaker device) upon selection by a user of user device 110.

In other implementations, nodes 115 may be individually configured to establish a connection (e.g., a persistent communication session) with user device 110. For example, a user of user device 110 may log into or otherwise access nodes 115 via a known network identifier, such as an IP address, etc. In one example, media delivery application 320 may provide an interface for enabling a user to designate an output node 115-x (e.g., by IP address, etc.) for receiving a media file or stream for output. In other implementations, a remote device, such a mobile phone (not shown), another output node 115, etc. may include an interface for initiating the streaming session.

Media delivery application 320 may receive media from service provider 120 via network 125. For example, media delivery application 320 may receive a media file or a media stream (e.g., a RTSP stream) from service provider 120. Exemplary media streams may include audio or video streams, including substantially live audio or video streams.

Media delivery application 320 may include a stand-alone application for accessing, requesting, and streaming media from service provider 120 via network 125. In other implementations, media delivery application 320 may be included within another application, such as a web browser application via, for example, a plug-in or other application infrastructure. In some implementations, media delivery application 320 may temporarily store the received media stream or file into a buffer or other memory structure (e.g., in memory 230) to facilitate smooth and uninterrupted delivery of the media stream or file to e.g., output device 250 or output node 115 via communication interface 260.

As will be described in additional detail below, the media received from service provider 120 may include advertisement media (generally “ads”). In some implementations, the ads may be embedded or otherwise inserted into the media prior to being received by user device 110. In other implementations, the ads may be independently delivered to user device 110 via, e.g., network 125. In this implementation, media delivery application 320 may periodically receive the ads from service provider 120 and insert or inject the ads into the received media stream, e.g., at times indicated by identifiable markers included within the media stream.

Node identifying logic 330 may include logic configured to determine information regarding a node 115-x receiving a media file or stream from user device 110 based on a name or identifier associated with output node 115-x. For example, node identifying logic 330 may receive names or identifiers associated with each output node 115-x receiving media from media delivery application 320. In one implementation, as briefly described above, a particular output node 115-x may respond to a device discovery request with a node identifier or name and a listing of supported services. Using the examples set forth above, node identifying logic 330 may receive the name “Susie's Room” or “Starbucks 1243” from output node 115-1.

Node identifying logic 330 may determine likely location or other related information relating to the particular output node 115-x based on the received name or identifier. In the example above, node identifying logic 330 may determine node information based on the received names “Susie's Room” and “Starbucks 1243.”

For example, node identifying logic 330 may initially determine whether the received node name or identifier includes any of a number of room identifying terms, such as “living room,” “dining room,” “kitchen,” “den,” “deck,” “garage,” “bedroom,” “office,” “family room,” “rec room,” “playroom,” “basement,” “patio,” “bathroom,” etc. If room identifying terms are included in the received node name, this information may be indicative of the activities associated with the identified room. For example, a room identifier of “kitchen,” may connote cooking and food related activities. Similarly, a room identifier of “family room,” may connote family entertainment activities, such as television/movie watching, gaming, reading, entertaining, etc.

Node identifying logic 330 may also determine whether the received node name or identifier includes a first name. In one implementation, memory 230 of user device 110 may store or otherwise access (e.g., via network 125) a listing of first names and related information. For example, a suitable listing of first names may include information regarding the sex primarily associated with the name as well as nicknames commonly associated with the name. In one embodiment, the listing of first names may also include statistical or demographic information associated with each name. The demographic information may include listings of age ranges associated with each name. For example, in the above example, node identifying logic 330 may determine that the node name “Susie's Room” includes the first name Susie. Node identifying logic 330 may further determine that “Susie” is a feminine nickname for Susan commonly used for females younger than 30 years of age.

Relating to a more commercial implementation, node identifying logic 330 may determine compare the assigned name to a database or listing of known businesses. For example, a suitable listing businesses may include information regarding the type of business, demographic information associated with typical business patrons, etc.

In some implementations consistent with aspects described herein, node identifying logic 330 may determine the node information based on a combination of elements, such as the presence of a first name in combination with one or more room identifying terms. For example, node identifying logic 330 may determine that a first name following by the general room identifying term “Room” (e.g., “Susie's Room”) is typically associated with a bedroom. Although not explicitly described herein, other types of disambiguation techniques may also be used to infer audience and/or location information from a name associated with an output node 115.

When media delivery application 320 is streaming or otherwise outputting media to the node, node identifying logic 330 may transmit the determined node information to service provider 120 via network 125 for use in delivering targeted ads to the particular output node 115-x. In the “Susie's Room” example above, node identifying logic 330 may transmit information indicating that the destination location of the media stream is the bedroom of a young woman or girl. Similarly, in the “Starbucks 1243” example, node identifying logic 330 may transmit information indicating that the destination location of the media stream is a coffee shop having a typical demographic range of 22-50 years of age, with a media household income of $50,000 to $100,00. Responsive to this information, media delivery application 320 may receive advertisements selected based on the node information associated with the output node 115-x. In other implementations, node information may be transmitted to service provider 120 prior to delivery or streaming of media content to user device 110.

In some implementations, media delivery application 320 may deliver media streams or files to more than one output node 115-x in a substantially synchronized manner. For example, media delivery application 330 may deliver the media stream to nodes 115-1 and 115-5. In this implementation, media delivery application 320 may receive a number of advertisements from service provider for potential inclusion with a media stream.

Node identifying logic 330 may determine node information for each of output nodes 115-1 and 115-5 based on the names associated with each output node. Node identifying logic 330 may insert different advertisements (selected from the received advertisements) into the respective media streams based on the node information. In an alternative implementation, media delivery application 320 may transmit requests for ads to service provider 120 based on the determined node information. The received ads may then be inserted into appropriate media streams.

In another implementation, node information for each output node (e.g., nodes 115-1 and 115-5 in the above example) may be transmitted to service provider for use in identifying or selecting ads for inclusion or insertion into the media stream.

Although described above in relation to user device 110, in other implementations, node identifying logic 330 may be included within or may be associated with service provider 120. In such an implementation, media delivery application 320 may transit the node name or identifier from the output node(s) 115 to service provider 120. Node identifying logic 330 at service provider 120 may then determine the node information corresponding to the output node(s) 115.

Media content storage 340 may include logic or memory structures (e.g., a buffer) configured to store or maintain media files or streams for delivery to output node(s) 115 via media delivery application 320. In some implementations, media content storage 340 may include an audio or video stream buffer for receiving a stream of media from service provider 120.

Although described above in the context of advertisement delivery, it should be noted that any aspect of the media delivery may be modified based on the identified node information. For example, a selection of music delivered to an output node may be based on the identified node information. Consider an output node 115 named “Gym.” Node identifying logic 330 may determine that the Gym output node is associated with a home or commercial fitness facility and is further associated with younger individuals. Although a streaming radio station entitled “Hot Hits” is being requested, the content of the station may be adjusted based on the identified node information. In contrast, a same streaming radio station transmitted to an output node named “bedroom” may be provided with a different selection of music.

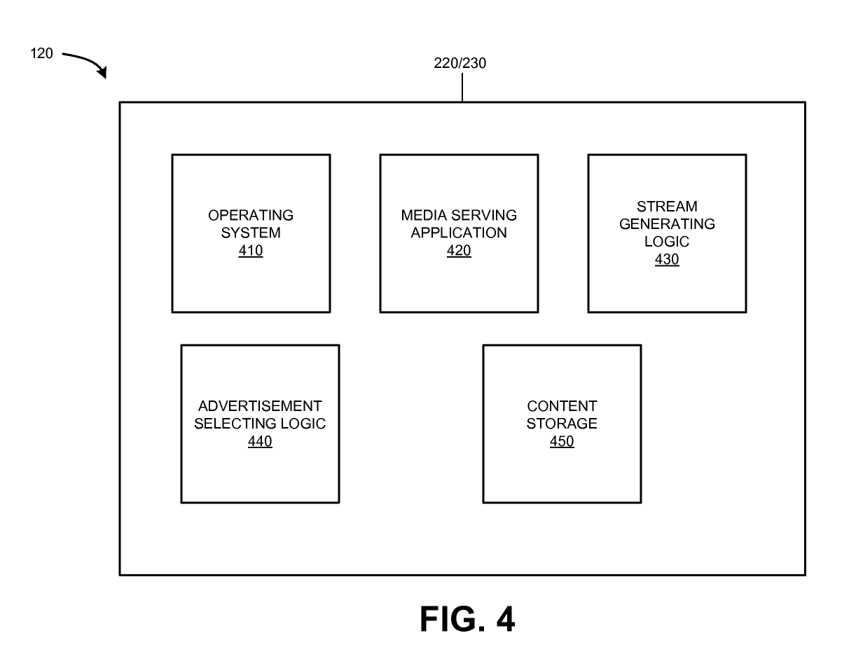

FIG. 4 illustrates one implementation of an exemplary functional block diagram of components implemented in service provider 120. The logical blocks illustrated in FIG. 4 may be implemented in software, hardware, a combination of hardware and software. In one exemplary implementation, the logical blocks illustrated in FIG. 4 may be included in memory 230 in service provider 120.

Referring to FIG. 4, memory 230 of service provider 120 may include an operating system 410, media serving logic 420, stream generating logic 430, and advertisement selecting logic 440 executable by processor 220. Memory 230 may further include content storage 450. Depending on the implementation, service provider 120 may include additional, fewer, or different components than those illustrated in FIG. 4. For example, as described above, service provider 120 may include a number of different devices (e.g., servers, gateways, decision engines, etc.) that together perform these functions.

Similar to operating system 310 described above, operating system 410 may include logic configured to manage hardware and software resources of service provider 120. Operating system 410 may manage, for example, its file system, device drivers, communication resources (e.g., radio receiver(s), transmission control protocol (TCP)/IP stack), event notifications, etc.

Media serving application 420 may include logic configured to receive and respond to media serving requests from user device 110. Media serving application 420 may include a single executable application (e.g., a stream serving application) or may include more than one executable application. In one exemplary implementation, media serving application 420 may communicate with user device 110 via network 120. More specifically, media serving application 420 may communicate with media delivery application 320 on user device 110 via respective communication interfaces 260. In response to the request, media serving application 420 may establish a media delivery (e.g., streaming) session with user device 110 via network 125. As will be described in additional detail below, media serving application 420 may receive a stream responsive to the user request from stream generating logic 430 and may transmit the media stream to user device 110 via the established session.

In one implementation, media serving application 420 may be configured to receive a media stream request from media delivery application 320. The media stream request may be based on various network protocols, such as HTTP (hyper-text transfer protocol), SIP (session initiation protocol), FTP (file transfer protocol), etc. In some implementations, media delivery application 320 may periodically transmit additional media stream requests or keepalive (e.g., heartbeat) messages to media serving application 420, to keep a streaming session active, for example. A media delivery session, such as a real time streaming protocol (RTSP) session may be established in response to the request. In some implementations, media serving application 420 may authenticate a request from user device 110 prior to establishment of the delivery session.

In the manner described above, media serving application 420 may receive node information obtained or determined by node identifying logic 330. For example, media serving application 420 may receive metadata type information relating to output destinations for the requested media stream. In one exemplary implementation, the node name information may be transmitted to media serving application 420 in web cookies or other messages associated with the streaming session. Extending the example initially set forth above, media serving application 420 may receive information indicating that the output destination for the requested media stream is a young girl/woman's bedroom. Additional information may also be included in the provided information, such as local time of day, general geographic location, history information, such as browser history information, media consumption information, purchase history information, etc.

Stream generating logic 430 may include logic configured to generate a media stream in response to the received (and authenticated) request. In one implementation, the media stream may include audio and/or video content retrieved from, e.g., content storage 450. The established media stream may comply with a number of suitable streaming protocols, such as RTSP.

The generated media stream may include periodic advertisements injected or inserted therein. For example, an audio stream may include advertisements at predetermined time intervals. A video stream may include overlay advertisements (e.g., ads overlaid onto the underlying video content of the stream) and/or video advertisements at predetermined time intervals. In other implementations, the video stream may be manipulated to insert products or other elements into the video stream. For example, a soda can may be made to appear on a table in a video stream. In some instances, the video stream may include predefined advertisement areas or elements (e.g., green screen elements) configured to dynamically receive advertisements. For example, a green screen may be positioned behind home plate at a baseball game. Advertisements may be placed onto the green screen during live streaming of the baseball game.

Consistent with implementations described herein, selection of advertisements for inclusion in the provided media stream may be based on the received node information. Advertisement selecting logic 440 may include logic configured to receive node information from media serving application 420. The node information may include metadata or demographic information relating to a likely audience of the stream. As described above, the metadata or demographic information may be inferred or determined based on the name assigned to the output node (e.g., node 115-x) for the media stream. In one implementation, node identifying logic 330 in user device 110 may determine or obtain the node information, while in other implementations, media serving application 420 and/or advertisement selecting logic 440 may determine the node information based on node name or identifier information received from user device 110, e.g., in the media request.

Advertisement selecting logic 440 may be further configured to select an advertisement (or advertisements) from a number of available advertisements based on the received (or determined) node information. For example, advertisement selecting logic 440 may generate an advertisement query based on the node information to an advertisement index or other data structure (e.g., an ad database). Advertisement selecting logic 440 may select the advertisement based on the ad's relevance to the node information or based on other criteria relative to the node information, such as target age/gender range, relationship to room activity or function information (e.g., cooking) included in the node information, etc. Stream generating logic 430 may insert or otherwise inject the selected advertisement into the media stream prior to transmission to user device 110. In other implementations, media streaming application 420 may transmit the selected advertisement(s) to user device 110 outside of the media stream. In this implementation, the selected advertisement(s) may be inserted into the media stream by media delivery application 320.

Content storage 450 may include logic or memory structures (e.g., a server, a database, a hard disk drive, a buffer, etc.) configured to store or maintain media files and/or advertisements for use by stream generating logic 430 and/or advertisement selecting logic 440. In some implementations, content storage 450 may include multimedia files, such as audio and/or video files.

Although described above in the context of advertisement delivery, it should be understood that any aspect of the media delivery may be modified based on the identified node information. For example, media serving application 420 may select music or other media based on the identified node information.

As briefly described above, user device 110 may output a media stream to more than one output node 115. In one implementation, media delivery application 320 may transmit node information for each of the connected output nodes 115 to media serving application 420. Advertisements selecting logic 440 may identify advertisements for each of output nodes 115 and may insert the selected advertisements into the stream with markers or tags associated therewith indicating an output node 115 for each advertisement. In this manner, an ad selected for “Susie's Room” is delivered to output node 115-1 and an ad selected for the “Kitchen” is delivered to the output node 115-4.

In other implementations, advertisement selecting logic 440 may be incorporated into media delivery application 320. In such implementations, media serving application 420 may transmit a number of advertisements to media delivery application 320, e.g., in an out of band manner. That is, the advertisements may be delivered outside of the media stream. Advertisement selecting logic 440 in media delivery application 320 may select particular ads from the received advertisements for each output node 115. As described above, the ads may be selected based on relevance or applicability to the corresponding node information associated with each output node 115.

### Exemplary Processing

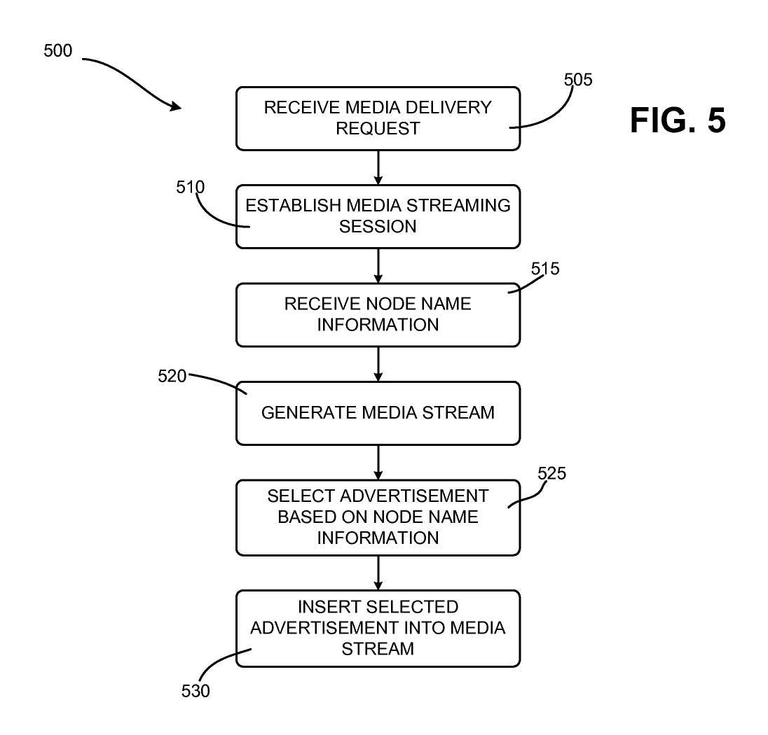

FIG. 5 is a flow diagram illustrating an exemplary process 500 for performing node name based advertising in the environment of FIG. 1. Processing may begin with service provider 120 receiving a media delivery request from user device 110 via network 125 (block 505). For example, media serving application 420 may receive a request to establish a media stream (e.g., an audio stream) from user device 110. Media serving application 420 may include a web server or other network device for receiving media requests via network 125.

Service provider 120 may establish a media streaming session with user device 110 based on the request (block 510). For example, a RSTP session may be established via network 125.

Service provider 120 may receive node identification information from user device 110, relating to one or more output nodes 115 selected for outputting the requested media stream (block 515). As described above, media delivery application 320 may provide an interface for enabling a user to select from a number of media sources, e.g., a media stream from service provider 120 and to output the selected media stream to one or more output nodes 115.

Media delivery application 320 may establish a media delivery session with the selected output node(s) 115 using RTSP or other suitable protocols. Further, media delivery application 320 may receive the node identification, such as a name (also referred to as “node name information”), from the selected output node 115. In some implementations, the node name information may be received prior to establishment of the media delivery session, such as during device discovery.

Service provider 120 may generate a media stream in response to the user request and may output the media stream via the established session (block 520). For example, stream generating logic 430 may be configured to generate the media stream in response to the received request.

Service provider 120 may select an advertisement for inclusion in the media stream based on the received node name information (block 525). As described above, advertisement selecting logic 440 may be configured to select an advertisement (or advertisements) from a number available advertisements based on metadata or demographic information determined from the received node name information. For example, a room name type, such as kitchen or den, may be associated with various information elements, such as location activity type, age demographics, etc. In some implementation, additional data associated with the request, such as time of day, geographic location, etc., may also be used in selecting the advertisement.

For example, a node name of “kitchen” may cause advertisement selecting logic 440 to select a grocery store advertisement for transmission to user device 110. In another example, a node name of “family room” may cause advertisement selecting logic 440 to select an advertisement for a recently released or upcoming movie.

Service provider 120 may insert the selected advertisement(s) into the media stream for transmission to user device 110 (block 530). For example, stream generating logic 430 may be configured to insert the advertisement(s) into the media stream for end delivery to the selected output node 115

Although the processing of FIG. 5 has been described above in relation to processing performed by service provider 120, in some implementations, some or all of the processing may be performed by user device 120, such as in implementations in which the number of available advertisements are transmitted en masse to user device 110 for insertion into media.

By selecting advertisements based on node name or other identification information, more efficient and targeted advertisement distribution may be supported. Enhanced ad targeting may, in turn, demand higher advertisement prices and, consequently, increased advertising revenue for ad-supported media providers, such as streaming music and video providers.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary processes illustrated in FIG. 5, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Further, the phrase “based on” is intended to mean “based, at least in part, on” unless explicitly stated otherwise.

What is claimed is:

1. A method, comprising:
receiving a media delivery request via a network;
receiving node name information associated with the media delivery request;
selecting an advertisement from a number of available advertisements based on the node name information;
including the selected advertisement with the media; and
transmitting the media via the network.

2. The method of claim 1,
wherein the media delivery request comprises a request for a media stream,
wherein the node name information is associated with an output node for outputting the media stream, and
wherein the selected advertisement is inserted into the media stream.

3. The method of claim, wherein the media stream comprises an audio stream.

4. The method of claim 1, wherein the node name information includes a name of an output node selected to receive the media.

5. The method of claim 4, wherein the output node comprises a speaker or a display.

6. The method of claim 1, further comprising:
determining node information based on the received node name information; and
selecting the advertisement from the number of available advertisements based on the determined node information.

7. The method of claim 6, wherein the media request is received from a user device, and wherein the media request includes the node information.

8. The method of claim 6, wherein the node information comprises gender information, age information, or location-related activity information.

9. The method of claim 1, wherein the received node name information includes first node name information associated with a first output node and second node name information associated with a second output node, the method comprising:
selecting a first advertisement from the number of available advertisements based on the first node name information;
selecting a second advertisement from the number of available advertisements based on the second node name information; and
including the first and second advertisements with the media,
wherein the first and second advertisements include markers therein for associating the first advertisement with the first output node and the second advertisement with the second output node.

10. A device, comprising:
a communication interface for communicating with a user device via a first network;
a memory for storing media content and a number of advertisements; and
logic configured to:
receive a request for the media content from the user device;
receive node name information associated with an output node of the user device;
select an advertisement from a number of available advertisements based on the node name information;
insert the selected advertisement into the media content; and
transmit the media content to the output node via the first network.

11. The device of claim 10, wherein the output node comprises a speaker or a display.

12. The device of claim 10, wherein the user device communicates with the output node via a second network, and wherein the node name information is associated with the output node.

13. The device of claim 10,
wherein the request for media content comprises a request for a media stream,
wherein the output node outputs the media stream, and
wherein the selected advertisement is inserted into the media stream.

14. The device of claim 13, wherein the node name information includes a name assigned to the output node.

15. The device of claim 10, wherein the logic is further configured to:
determine node information based on the received node name information; and
select the advertisement from the number of available advertisements based on the determined node information.

16. The device of claim 15, wherein the determined node information comprises gender information, age information, location information, or activity information corresponding to an audience at the output node.

17. A computer-readable medium having stored thereon a plurality of sequences of instructions which, when executed by at least one processor, cause the at least one processor to:
store media content that includes a number of available media items;
receive a user command to output a media stream to a selected output node;
obtain name information associated with the selected output node;
determine node information based on the name information;
select particular media items from the number of available media items based on the node information;
insert the selected media items into the media stream; and
output the media stream to the selected output node.

18. The computer-readable medium of claim 17, wherein the instructions which cause the at least one processor to determine node information further comprise instructions that cause the at least one processor to:
determine a function associated with a location of the output node;
determine a gender associated with an audience at the output node; or
determine an age associated with the audience at the output node.

19. The computer-readable medium of claim 17, wherein the instructions further cause the at least one processor to:
receive the media stream from a network device via a computer network,
wherein the instructions to select particular media items from the number of available media items based on the node information and insert the particular media items into the media stream are performed at the network device.

20. The computer-readable medium of claim 19, wherein the media stream comprises a substantially live audio or video stream.
